(19) United States
(12) Patent Application Publication
(10) Pub. No.: US 2024/0297005 A1
(43) Pub. Date: Sep. 5, 2024

(54) GAS CIRCUIT BREAKER

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Tomohiko JIMBO, Fujisawa (JP); Biswas DEBASISH, Shiki (JP); Amane MAJIMA, Kawasaki (JP); Tooru INOUE, Yokohama (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/455,065

(22) Filed: Aug. 24, 2023

(30) Foreign Application Priority Data
Mar. 3, 2023 (JP) 2023-032440

(51) Int. Cl. H01H 33/91; H01H 33/56

(52) U.S. Cl. CPC H01H 33/91; H01H 33/56; H01H 2033/566

(57) ABSTRACT

The gas-circuit-breaker includes a container, opposing part, movable-part, and nozzle. An arc-extinguishing gas fills the container. The opposing-part is housed in the container and includes an opposing-arc-contact and an exhaust stack. The movable-part is housed in the container and includes a movable-arc-contact coming in contact with the opposing-arc-contact in a connected-state and separating from the opposing-arc-contact in an open-state; and a pressure-accumulation-part where an arc-extinguishing gas pressure increases. The nozzle is housed in the container and includes a space where arc-discharge occurs between the movable-arc-contact and the opposing-arc-contact. The nozzle includes a middle-part where the opposing-arc-contact is inserted and one or more jet-holes that eject, toward the space, partial arc-extinguishing gas flowing in from a flow-passage between the pressure-accumulation-part and the middle-part. The arc-extinguishing gas whose pressure increases in the pressure-accumulation-part flows into the space via the flow-passage and the jet-holes to extinguish the arc-discharge.

### CROSS-REFERENCE TO RELATED APPLICATIONS

This application is based upon and claims the benefit of priority from Japanese Patent Application No. 2023-032440, filed on Mar. 3, 2023; the entire contents of which are incorporated herein by reference.

### FIELD

Embodiments described herein relate generally to a gas circuit breaker.

### BACKGROUND

A conventionally known gas circuit breaker has two contact parts constituting an electric path, and extinguishes arc discharge that occurs between the two contact parts by blowing an arc-extinguishing gas.

For this type of gas circuit breaker, for example, more smooth or ensured extinguishing of arc discharge would be significant.

### BRIEF DESCRIPTION OF THE DRAWINGS

FIG. 1 is a sectional view of a gas circuit breaker according to an embodiment, which illustrates a connected state;

FIG. 2 is a sectional view of the gas circuit breaker according to the embodiment, which illustrates an open state;

FIG. 3 is a diagram illustrating an open state after the state of FIG. 2;

FIG. 4 is a sectional view taken along line V-V in FIG. 1;

FIG. 5 is a sectional view taken along line VI-VI in FIG. 1;

FIG. 6 is a diagram illustrating an example of a structure of a gas circuit breaker according to a second embodiment;

FIG. 7 is a sectional view taken along line VII-VII in FIG. 6;

FIG. 8 is a diagram illustrating an example of a structure of gas chambers divided into four in a circumferential direction; and

FIG. 9 is a chart illustrating a time history of temperatures in the vicinity of an opposing arc contact.

### DETAILED DESCRIPTION

A gas circuit breaker according to an embodiment includes a container, an opposing part, a movable part, and a nozzle. The container is filled with an arc-extinguishing gas. The opposing part is housed in the container. The opposing part includes an opposing arc contact and an exhaust stack. The movable part is housed in the container. The movable part includes a movable arc contact that comes in contact with the opposing arc contact in a connected state, and separates from the opposing arc contact in an open state; and a pressure accumulation part where a pressure of the arc-extinguishing gas is increased. The nozzle is housed in the container and includes a space where arc discharge occurs between the movable arc contact and the opposing arc contact. The nozzle includes a middle part where the opposing arc contact is inserted, and includes one or more jet holes that eject, toward the space, part of the arc-extinguishing gas flowing in from a first flow passage between the pressure accumulation part and the middle part. The arc-extinguishing gas whose pressure is increased in the pressure accumulation part flows into the space via the first flow passage and the jet holes to extinguish the arc discharge. Hereinafter, exemplary embodiments of the present application will be disclosed. The structures and control (technical features) of the embodiments described below as well as the actions and results (effects) brought about by such structures and control are examples. Furthermore, plural embodiments illustrated below include similar structural components. Hereafter, common reference signs are applied to similar structural components, and duplicate explanations will be omitted.

In order to effectively cool arc discharge, it is necessary to significantly increase the pressure in a puffer chamber that is a pressure accumulation space, and increase an exhaust flow rate of a gas stream. The pressure increase in the puffer chamber acts as a driving reaction force when the pressure acting on a puffer piston drives it to open. A large driving force is required to significantly increase the pressure in the puffer chamber. In order to generate a large driving force, it is necessary to increase the size of a driving device. Furthermore, as the pressure in the puffer chamber increases, the weight of a movable contact including the puffer chamber increases for increasing the mechanical strength to withstand the pressure, causing the necessity to increase the drive energy further.

Therefore, in recent years, a method for downsizing the puffer chamber and decreasing the reaction force and a method for accumulating the pressure in the puffer chamber using a hot arc-extinguishing gas that is heated by arc discharge have been developed.

However, downsizing the puffer piston reduces the mass of the arc-extinguishing gas blown onto the arc discharge, which may cause problems such as a decrease in the gas density and an increase in the gas temperature. A decrease in the gas density leads to a decrease in the dynamic pressure.

Furthermore, a sulfur hexafluoride gas or the like often used as an arc-extinguishing gas (insulating gas) causes a very high greenhouse effect, so that it is necessary to develop a gas circuit breaker that uses alternative gases. However, with alternative gases, due to the gas properties, the arc may not be cooled (insulated) sufficiently, thereby failing to interrupt an electric current. In addition, the flow may be separated at an insulating nozzle part where the cross-sectional area of the flow passage widens, and the hot gas stays therein without flowing downstream, thereby causing insulation breakdown.

The gas circuit breaker according to the embodiments described below cools the arc more effectively and improves the current breaking performance over a wider breaking current area, even when alternative gases are used as the arc-extinguishing gas.

### First Embodiment

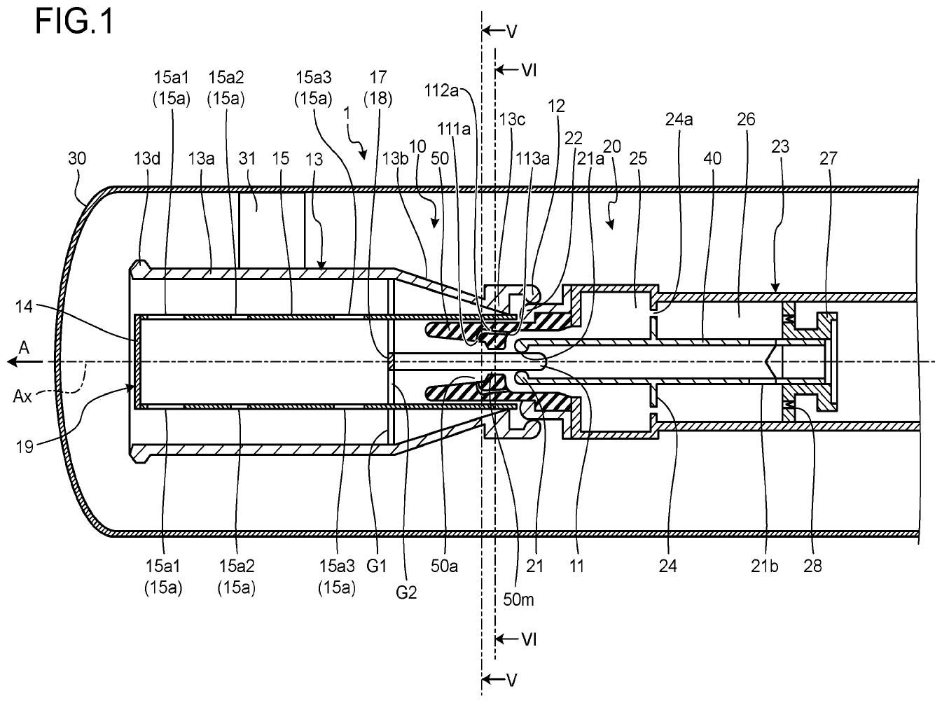

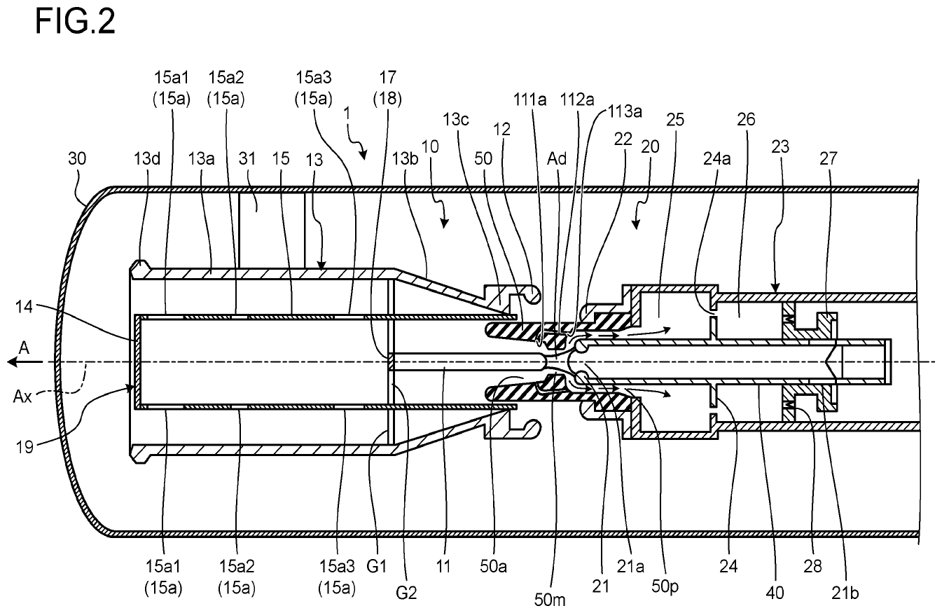

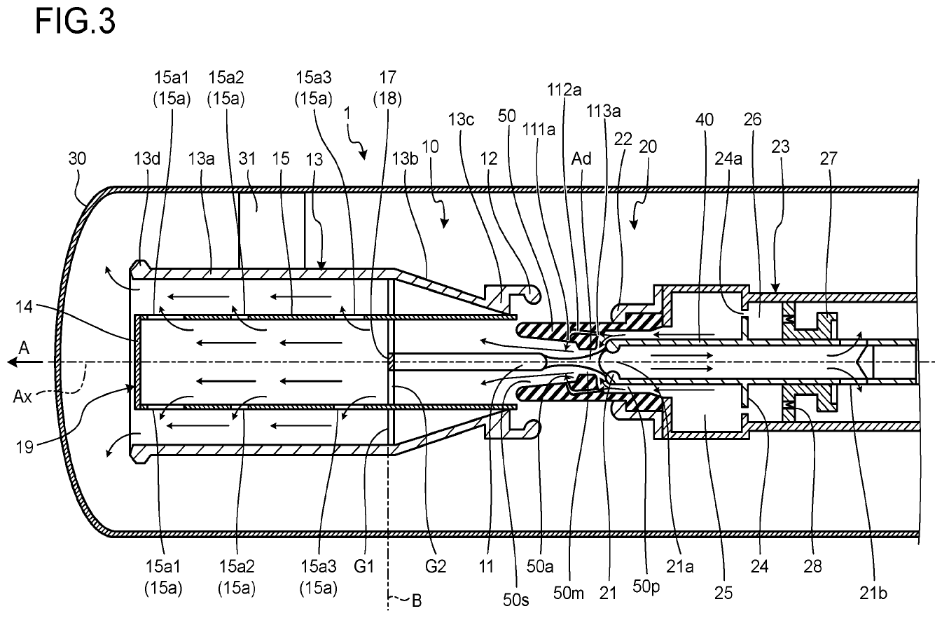

As illustrated in FIG. 1 to FIG. 3, a gas circuit breaker 1 includes an opposing contact part 10 and a movable contact part 20 as two contact parts constituting an electric path. The gas circuit breaker 1 switches between a connected state (FIG. 1) where the opposing contact part 10 and the movable contact part 20 are in contact with each other, and an open state (FIG. 2 and FIG. 3) where the opposing contact part 10 and the movable contact part 20 are separated from each other. In the open state after the connected state, an arc discharge occurs between the opposing contact part 10 and the movable contact part 20. By blowing a flow of an arc-extinguishing gas onto the arc discharge, the arc discharge is insulated, cooled, and extinguished at the current zero point, thereby interrupting the current. The connected state may also be referred to as a contact state, and the open state may also be referred to as a separated state.

As illustrated in FIG. 1, the gas circuit breaker 1 includes a sealed container 30. The sealed container 30 is filled with an arc-extinguishing gas. The sealed container 30 is, for example, composed of a metal material, an insulator, or the like, and it is connected to ground. The sealed container 30 is an example of a container.

The arc-extinguishing gas is, for example, a gas with excellent arc-extinguishing and insulation performance such as a sulfur hexafluoride gas (SF6 gas), air, carbon dioxide, oxygen, nitrogen, mixtures of those, or the like. Note that the arc-extinguishing gas may be, for example, a gas that has a lower global warming potential and lower molecular weight than the SF6 gas has, and is in a gas phase at least at 1 atmospheric pressure or higher and 20 degrees Celsius or lower.

In the sealed container 30, the opposing contact part 10 and the movable contact part 20 are disposed opposing to each other. The opposing contact part 10 and the movable contact part 20 each have a plurality of members, such as cylindrical or columnar members, and are concentrically disposed with each other around a central axis Ax. In the following, “axial direction” is the axial direction of the central axis Ax, “radial direction” is the radial direction of the central axis Ax, and “circumferential direction” is the circumferential direction of the central axis Ax. The opposing contact part 10 is an example of an opposing part, and the movable contact part 20 is an example of a movable part. Furthermore, in the following, the opposing contact part 10 side in the axial direction, that is, the left side in FIG. 1 to FIG. 3, is referred to as an axial direction A, and the movable contact part 20 side in the axial direction, that is, the right side in FIG. 1 to FIG. 3, is referred to as the other direction of the axial direction A, for convenience. Furthermore, since the opposing contact part 10 is fixed to the sealed container 30 in the present embodiment, it may also be referred to as a fixed contact part.

From the inner face of the sealed container 30, a support member 31 protrudes inwardly in the radial direction. The opposing contact part 10 is fixed to the sealed container 30 via the support member 31. The support member 31 insulates the sealed container 30 and the opposing contact part 10. Thus, the support member 31 may also be referred to as an insulating support member.

The movable contact part 20 is connected to an operation rod 40. The operation rod 40 is structured in a cylindrical shape extending along the axial direction A about the central axis Ax, and it is structured to be capable of reciprocating along the central axis Ax. The operation rod 40 is moved along the axial direction A by a drive device (not illustrated). The movable contact part 20 moves in the axial direction A in conjunction with the operation rod 40. When the operation rod 40 moves in the direction approaching the opposing contact part 10, that is, in the axial direction A, the opposing contact part 10 and the movable contact part 20 come to be in the connected state, as illustrated in FIG. 1. When the operation rod 40 moves in the direction away from the opposing contact part 10, that is, in the other direction of the axial direction A, the opposing contact part 10 and the movable contact part 20 come to be in an open state, as illustrated in FIG. 2 and FIG. 3. Furthermore, the operation rod 40 also functions as a discharge pipe for the arc-extinguishing gas. In other words, the arc-extinguishing gas can enter the cylinder of the operation rod 40 from the end part in the axial direction A, pass through the cylinder, and flow out into the sealed container 30 via an opening part 21b.

The opposing contact part 10 includes an opposing arc contact 11 and an opposing current-carrying contact 12. Furthermore, the movable contact part 20 includes a movable arc contact 21 and a movable current-carrying contact 22. The opposing arc contact 11 and the movable arc contact 21 oppose to each other in the axial direction A, and electrically connected in the connected state. Furthermore, the opposing current-carrying contact 12 and the movable current-carrying contact 22 oppose to each other in the axial direction A, and are electrically connected in the connected state. When the opposing contact part 10 is fixed to the sealed container 30, the opposing arc contact 11 may also be referred to as a fixed arc contact, and the opposing current-carrying contact 12 may also be referred to as a fixed current-carrying contact.

The opposing arc contact 11 is a rod-shaped conductor, and extends along the axial direction A about the central axis Ax. Inside an exhaust stack 13 of the opposing contact part 10, a disk-shaped first shield wall 14 orthogonal to the axial direction A is provided. Furthermore, from the first shield wall 14, a second shield wall 15 extending along the axial direction A is provided toward the other direction of the axial direction A.

The movable arc contact 21 is a tubular conductor, and extends along the axial direction A about the central axis Ax. In the present embodiment, as an example, the movable arc contact 21 is integrated with the operation rod 40. At an end part of the movable arc contact 21 in the axial direction A, a circular through-hole 21a is provided. The end part where the through-hole 21a is provided is divided into a plurality of finger-shaped electrodes extending along the axial direction A by a plurality of slits (not illustrated) extending along the axial direction A. The end parts of the finger-shaped electrodes are aligned along an edge of a diameter that is smaller than the outer peripheral face of the opposing arc contact 11. Along with the move of the operation rod 40, the movable arc contact 21 approaches the opposing arc contact 11, and the opposing arc contact 11 is inserted into the through-hole 21a, as illustrated in FIG. 1. Whereby, the finger-shaped electrodes are pushed by the outer peripheral face of the opposing arc contact 11 and spread outward in the radial direction to be in contact with the outer peripheral face of the opposing arc contact 11 by the elastic force of the finger-shaped electrodes.

The tip parts of the opposing arc contact 11 and the movable arc contact 21 are covered by an insulating nozzle 50 with a gap provided therebetween. The insulating nozzle 50 is made of, for example, a heat-resistant and insulating material such as polytetrafluoroethylene. In the present embodiment, as an example, the insulating nozzle 50 is fixed at the end part of the movable contact part 20 in the axial direction A, and moves in the axial direction A together with the operation rod 40 and a cylinder 23. The insulating nozzle 50 has a cylindrical outer face, and extends along the axial direction A about the central axis Ax. The insulating nozzle 50 is an example of a nozzle.

The insulating nozzle 50 has an opening part 50a that is opened through in the axial direction A about the central axis Ax. As illustrated in FIG. 1, the opposing arc contact 11 can be inserted in a middle part 50m of the opening part 50a in the axial direction A with a gap provided therebetween. The middle part 50m may also be referred to as a throat. Furthermore, as illustrated in FIG. 2 and FIG. 3, the movable arc contact 21 is inserted between the middle part 50m of the opening part 50a and a thermal puffer chamber 25 with a gap provided therebetween. This gap constitutes a passage 50p of the arc-extinguishing gas between the middle part 50m and the thermal puffer chamber 25. Furthermore, between the middle part 50m and the end part of the insulating nozzle 50 in the axial direction A, a conical face shaped diameter-enlarged part is formed with the diameter widened toward the end part. As illustrated in FIG. 3, the diameter-enlarged part constitutes a passage 50s of the arc-extinguishing gas between the middle part 50m and the exhaust stack 13. The opening part 50a is an example of a space.

The opposing current-carrying contact 12 is a tubular conductor, and extends along the axial direction A about the central axis Ax. The opposing current-carrying contact 12 is joined at the outer peripheral face of the end part of the exhaust stack 13 in the other direction of the axial direction A. The opening edge of the opposing current-carrying contact 12 in the longitudinal direction of the opposing current-carrying contact 12 protrudes inwardly in the radial direction.

The movable current-carrying contact 22 is a tubular conductor, and extends along the axial direction A about the central axis Ax. The movable contact part 20 includes the cylinder 23 in a cylindrical shape that houses the operation rod 40. The movable current-carrying contact 22 is joined at the end part of the cylinder 23 in the axial direction A. Along with the move of the operation rod 40, the movable current-carrying contact 22 approaches the opposing current-carrying contact 12 and inserted into the opposing current-carrying contact 12, as illustrated in FIG. 1. The inner diameter of the opening edge of the opposing current-carrying contact 12 and the outer diameter of the movable current-carrying contact 22 are substantially the same, and the opposing current-carrying contact 12 and the movable current-carrying contact 22 are electrically connected in a state where the movable current-carrying contact 22 is being inserted into the opposing current-carrying contact 12.

In the structure described above, in the open state after the connected state, as illustrated in FIG. 2 and FIG. 3, an arc discharge Ad occurs between the opposing arc contact 11 and the movable arc contact 21 inside the opening part 50a of the insulating nozzle 50. The generated arc discharge Ad is extinguished by a flow of the arc-extinguishing gas. Hereafter, the flow of the arc-extinguishing gas may also be referred to simply as a gas flow.

The gas flow is generated in the cylinder 23. The cylinder 23 is a tubular conductor, and extends along the axial direction A about the central axis Ax. The cylinder 23 is fixed to the operation rod 40. In other words, along with the move of the operation rod 40, the cylinder 23 also moves.

Between the cylinder 23 and the operation rod 40, an annular space is provided. The annular space is partitioned in the axial direction A by a partition wall 24 extending in the radial direction, thereby forming the thermal puffer chamber 25 and a mechanical puffer chamber 26. The gas flow that is blown onto the arc discharge Ad is generated in the thermal puffer chamber 25 and the mechanical puffer chamber 26. The partition wall 24 has a plurality of through-holes 24a provided therein. The arc-extinguishing gas can travel back and forth between the thermal puffer chamber 25 and the mechanical puffer chamber 26 via the through holes 24a. The thermal puffer chamber 25 and the mechanical puffer chamber 26 are examples of a pressure accumulation part, which may also be referred to as a pressure accumulation space.

In the thermal puffer chamber 25, the pressure of the arc-extinguishing gas is increased by the thermal energy generated by the arc discharge Ad between the opposing arc contact 11 and the movable arc contact 21 as illustrated in FIG. 2. Specifically, as indicated by arrows in FIG. 2, the pressure wave generated by the thermal energy of the arc discharge Ad is introduced into the thermal puffer chamber 25, thereby increasing the pressure in the thermal puffer chamber 25.

In the mechanical puffer chamber 26, on the opposite side of the partition wall 24, a piston 27 fixed to the sealed container 30 is disposed. The piston 27 is housed in the cylinder 23 to be relatively slidable with the cylinder 23 and the operation rod 40 in the axial direction A. As is clear by comparing FIG. 2 and FIG. 3 with FIG. 1, when the cylinder 23 and the operation rod 40 move in the other direction of the axial direction A, the distance between the partition wall 24 and the piston 27 is shortened and the volume of the mechanical puffer chamber 26 becomes smaller. This reduction in the volume of the mechanical puffer chamber 26 increases the pressure of the arc-extinguishing gas in the mechanical puffer chamber 26. Note that the piston 27 has a relief valve 28 that opens with a pressure of a prescribed value or more. The relief valve 28 suppresses the pressure in the mechanical puffer chamber 26 from rising to a prescribed value or more.

As illustrated in FIG. 2, when the arc discharge Ad occurs between the opposing arc contact 11 and the movable arc contact 21, a pressure wave of the arc-extinguishing gas is introduced into the thermal puffer chamber 25 via the passage 50p of the insulating nozzle 50, thereby increasing the pressure in the thermal puffer chamber 25. Furthermore, the pressure in the mechanical puffer chamber 26 increases in accordance with the relative move of the cylinder 23, the operation rod 40, and the piston 27, as described above. As illustrated in FIG. 3, in accordance with the pressure increase, the arc-extinguishing gas in the mechanical puffer chamber 26 flows into the thermal puffer chamber 25 via the through-holes 24a and, together with the arc-extinguishing gas in the thermal puffer chamber 25, acts on the arc discharge Ad via the passage 50p in the insulating nozzle 50 to extinguish the arc discharge Ad.

The exhaust stack 13 includes a cylindrical part 13a and a conical part 13b. The cylindrical part 13a is positioned on the axial direction A side of the exhaust stack 13. Furthermore, the conical part 13b is positioned on the side in the other direction of the axial direction A of the exhaust stack 13. The conical part 13b is structured to be gradually tapered from the cylindrical part 13a toward an end part 13c on the movable contact part 20 side. The conical part 13b may also be referred to as a diffuser.

As illustrated in FIG. 1 to FIG. 3, a shield part 19 is provided inside the exhaust stack 13. The shield part 19 includes the first shield wall 14 and the second shield wall 15. The first shield wall 14 is structured in a disk shape orthogonal to the axial direction A. The first shield wall 14 may also be referred to as a shield plate.

The second shield wall 15 is structured in a cylindrical shape extending along the axial direction A about the central axis Ax. The second shield wall 15 extends from the end part of the first shield wall 14 on the outward side of the radial direction toward the end part 13c of the exhaust stack 13 in the other direction of the axial direction A. The second shield wall 15 is in contact with the end part 13c, that is, the opening edge, of the exhaust stack 13. In other words, the space between the second shield wall 15 and the conical part 13b is almost closed by the end part 13c. The second shield wall 15 may be in a tubular shape other than a cylindrical shape, such as a tubular shape with a polygonal cross section or the like, for example. The second shield wall 15 may also be referred to as a shield cylinder.

The second shield wall 15 has through-holes 15a provided therein. More specifically, in the second shield wall 15, a plurality of through-holes 15a is provided at an interval along the axial direction A. Those through-holes 15a constitute a row along the axial direction A. In the present embodiment, a plurality of rows constituted with the through-holes 15a are provided at an interval in the circumferential direction of the exhaust stack 13. In the present embodiment, as an example, three through-holes 15a (through-holes 15a1, 15a2, 15a3) are provided along the axial direction A in each row.

As is clear from FIG. 1 to FIG. 3, the insulating nozzle 50 is inserted into the second shield wall 15 and moves along the axial direction A inside the second shield wall 15. Furthermore, a relatively narrow clearance is provided between the inner face of the second shield wall 15 and the outer face of the insulating nozzle 50. This prevents leakage of the arc-extinguishing gas from the gap between the second shield wall 15 and the insulating nozzle 50. The inner face of the second shield wall 15 is an example of a guide part that guides the insulating nozzle 50.

The second shield wall 15 has the through-holes 15a provided therein. Via the through-holes 15a, the space inside the second shield wall 15 and the space outside the second shield wall 15 are connected.

Thus, as illustrated in FIG. 3, in the exhaust stack 13, the arc-extinguishing gas from the insulating nozzle 50 flows out from the space inside the second shield wall 15 to the space outside the second shield wall 15 via a gap G2 and the through-holes 15a. Furthermore, the arc-extinguishing gas flows into the space inside the cylindrical part 13a and flows out from an end part 13d of the exhaust stack 13 into the sealed container 30. At this time, the pressure in the thermal puffer chamber 25 and the mechanical puffer chamber 26 (pressure accumulation part) is higher than the pressure in the insulating nozzle 50, and the pressure in the insulating nozzle 50 is higher than the pressure in the exhaust stack 13.

Furthermore, at this time, the arc-extinguishing gas flowed into the second shield wall 15 passes between the opposing arc contact 11 and the second shield wall 15 at supersonic speeds. More specifically, in the present embodiment, the arc-extinguishing gas passes between a structure 18 and the second shield wall 15 at supersonic speeds. The arc-extinguishing gas then becomes subsonic inside the second shield wall 15 after passing between the structure 18 including the opposing arc contact 11 and the second shield wall 15. This is because, in the area inside the second shield wall 15 in the axial direction A, the cross-sectional area of the space that serves as the passage for the arc-extinguishing gas increases more rapidly in the area where the structure 18 is not provided than in the area where the structure 18 is provided. As a result, a shock wave is generated, thereby decelerating the speeds to subsonic speeds. The arc-extinguishing gas, which has become subsonic, then flows into the through-holes 15a. In FIG. 3, the arc-extinguishing gas flows at supersonic speeds on the right side of a dashed line B, and flows at subsonic speeds on the left side of the dashed line B. As described above, the shield part 19 (the first shield wall 14 and the second shield wall 15) allows the flow of the arc-extinguishing gas in the exhaust stack 13 via the gaps G1, G2 and the through-holes 15a. The gaps G1, G2 and the through-holes 15a are passages for the arc-extinguishing gas. Note that the gap G1 can also be considered an opening part provided in the structure including a support member 16, the second shield wall 15, and the exhaust stack 13. Furthermore, the gap G2 can also be considered an opening part provided in the structure including a support member 17 and the second shield wall 15.

In the present embodiment, in order to cool the arc more effectively, a jet hole that ejects the arc-extinguishing gas against the arc discharge Ad is provided. For example, as illustrated in FIG. 1 to FIG. 3, the insulating nozzle 50 is provided with one or more jet holes 111a, one or more flow passages 112a, and one or more inflow holes 113a.

The inflow hole 113a is an example of a hole through which part of the arc-extinguishing gas flowing in the passage 50p flows in. The passage 50p corresponds to a flow passage (first flow passage) of the arc-extinguishing gas between the middle part 50m (an example of a middle part) and the thermal puffer chamber 25.

The jet hole 111a is a hole for ejecting an unsteady jet flow of the arc-extinguishing gas against the arc discharge Ad. The jet hole 111a may be provided at any positions in the insulating nozzle 50, for example, in the middle part 50m where the cross-sectional area of the flow passage is constant, or in the diameter-enlarged part. The positions of the jet holes 111a may be determined, for example, as the positions where the arc-extinguishing gas is ejected at the timing where the arc discharge Ad can be more efficiently extinguished during the period of an open state. Furthermore, the size of the jet holes 111a may be the size to be able to eject the arc-extinguishing gas as a jet flow. For example, the jet holes 111a are in a size at least smaller than the cross-sectional area of the passage 50p.

The flow passage 112a is a flow passage (jet-forming flow passage) for forming a jet flow ejected from the jet hole 111a. The flow passage 112a is an example of a flow passage (second flow passage) through which part of the arc-extinguishing gas flowing in from the passage 50p flows.

With such a structure, the arc-extinguishing gas whose pressure is increased in the pressure accumulation part flows into the opening part 50a via the passage 50p, and it is ejected from the jet holes 111a through the flow passages 112a toward the arc discharge Ad, thereby extinguishing the arc discharge Ad.

At least one of the one or more jet holes 111a is provided to be able to eject a jet flow of the arc-extinguishing gas against the arc discharge Ad. This creates a flow of the arc-extinguishing gas toward the center of the arc discharge Ad, and vortexes around various axes different from the central axis Ax. As a result, heat transfer is promoted, so that the arc discharge Ad can be cooled more effectively. The jet flow can also eliminate stagnation of the hot insulating gas associated with flow separation that may occur in areas of the insulating nozzle 50 where the cross-sectional area of the flow passage gradually expands.

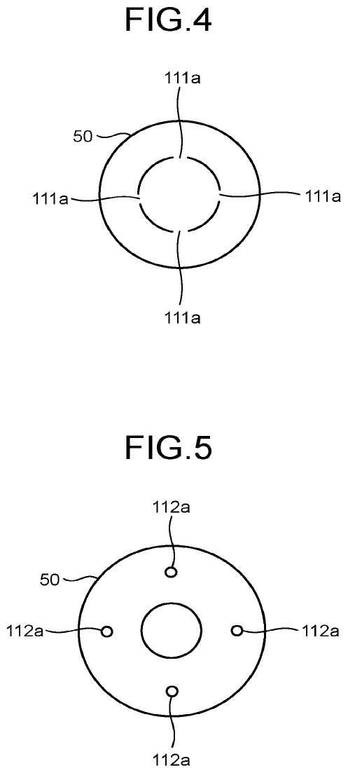

FIG. 4 is a sectional view taken along line V-V in FIG. 1. FIG. 5 is a sectional view taken along line VI-VI in FIG. 1. FIG. 4 and FIG. 5 correspond to cross sections orthogonal to the axial direction A in the areas where the jet holes 111a and the flow passages 112a are provided, respectively. FIG. 4 and FIG. 5 illustrate examples where the four jet holes 111a and the four flow passages 112a are provided in an axially symmetrical manner about the central axis Ax, respectively.

The structures in FIG. 4 and FIG. 5 are examples only, and the structures are not limited thereto. As for the jet holes 111a and the flow passages 112a, one of each simply need to be provided. When a plurality of jet holes 111a and a plurality of flow passages 112a are provided, the jet holes 111a and the flow passages 112a do not need to be axially symmetric about the central axis Ax.

There is no need for the jet hole 111a and the flow passage 112a (inflow hole 113a) to correspond to each other on a one-to-one basis. For example, the flow passage 112a may be formed such that the arc-extinguishing gas flowed in from a single inflow hole 113a is ejected from a plurality of jet holes 111a. Furthermore, the flow passage 112a may be formed such that the arc-extinguishing gas flowed in from a plurality of inflow holes 113a is ejected from a single jet hole 111a.

When a plurality of inflow holes 113a is provided, each of the inflow holes 113a does not need to be provided at the same position in the axial direction. Similarly, when a plurality of jet holes 111a is provided, each of the jet holes 111a does not need to be provided at the same position in the axial direction. For example, some of the jet holes 111a may be provided in the middle part 50m, while the rest of the jet holes 111a may be provided in the diameter-enlarged part. This allows the arc-extinguishing gas to be ejected against the arc discharge Ad at more timings included in the period of the open state.

When a plurality of inflow holes 113a is provided, the inflow holes 113a may be in different sizes from each other. When a plurality of jet holes 111a is provided, the jet holes 111a may be in different sizes from each other. When a plurality of flow passages 112a is provided, the flow passages 112a may have different cross-sectional areas from each other.

As described, the first embodiment includes the jet holes 111a, so that it is possible to cool the arc more effectively and improve the current breaking performance over a wider breaking current area, even when alternative gases are used as the arc-extinguishing gas.

### Second Embodiment

A gas circuit breaker according to a second embodiment includes a gas chamber instead of the flow passage 112a of the first embodiment. The gas chamber corresponds to a housing part into which part of the arc-extinguishing gas flowing in the passage 50p flows, the housing part housing the arc-extinguishing gas flowed therein, and ejecting the housed arc-extinguishing gas from one or more jet holes.

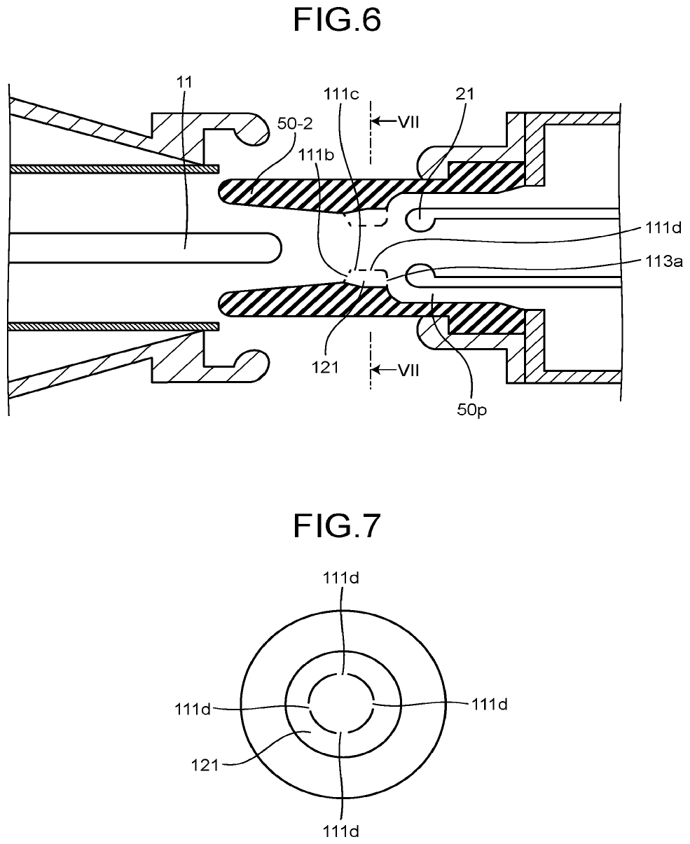

FIG. 6 is a diagram illustrating an example of the structure of the gas circuit breaker according to the second embodiment. In the second embodiment, the structure of an insulating nozzle 50-2 is different from that of the insulating nozzle 50 of the first embodiment. Other structural components are the same as those of the first embodiment, so that illustration thereof are omitted in FIG. 6 or the same reference signs are given thereto. Explanation of the structural components to which the same reference signs are given is omitted.

The insulating nozzle 50-2 includes one or more jet holes 111b, 111c, and 111d, one or more gas chambers 121, and one or more inflow holes 113a. In the example of FIG. 6, the gas chamber 121 is structured to house the arc-extinguishing gas flowing in from the inflow hole 113a and to eject the housed arc-extinguishing gas from the three jet holes 111b, 111c, and 111d whose positions in the axial direction are different from each other.

FIG. 7 is a sectional view taken along line VII-VII in FIG. 6. FIG. 7 corresponds to a cross section orthogonal to the axial direction A in the area where the jet holes 111d are provided. FIG. 7 illustrates an example of a single gas chamber 121 that is not divided in the circumferential direction. In other words, in the example of FIG. 7, the insulating nozzle 50-2 includes a single gas chamber 121. Furthermore, FIG. 7 illustrates an example where the four jet holes 111d are provided in an axially symmetrical manner about the central axis Ax. The insulating nozzle 50-2 may include, for example, four inflow holes 113a, four jet holes 111b, and four jet holes 111c, which are provided in an axially symmetrical manner by corresponding to the four jet holes 111d, respectively.

The gas chamber 121 houses the arc-extinguishing gas flowing in from the four inflow holes 113a, for example, and ejects the housed arc-extinguishing gas from 4×3 jet holes (jet holes 111b, 111c, 111d).

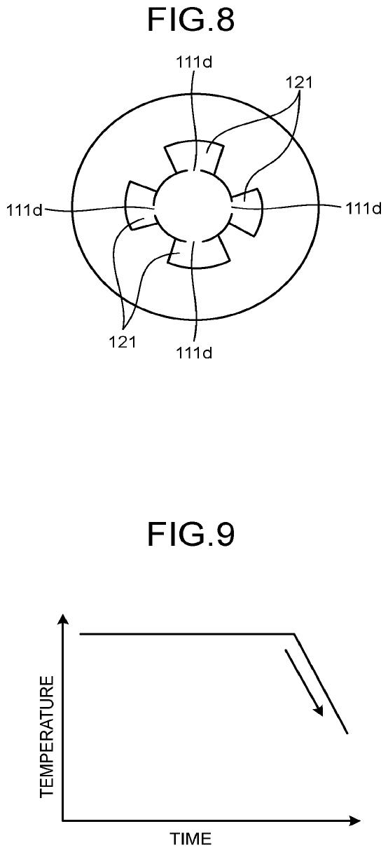

The structure of the gas chamber 121 is not limited to that illustrated in FIG. 7. For example, a plurality of gas chambers 121 divided in the circumferential direction may be provided. FIG. 8 is a diagram illustrating an example of the structure of the gas chambers 121 divided into four in the circumferential direction.

Each of the four gas chambers 121 corresponds to any one of the four inflow holes 113a, any one of the four jet holes 111b, and any one of the four jet holes 111c, for example. Then, each of the four gas chambers 121 houses the arc-extinguishing gas flowing in from the corresponding inflow hole 113a, and ejects the housed arc-extinguishing gas from the corresponding three jet holes (jet holes 111b, 111c, 111d).

Next, current interruption according to the above described embodiments (first embodiment and second embodiment) will be described. FIG. 9 is a chart illustrating a time history of the temperatures in the vicinity of the opposing arc contact 11. The horizontal axis in FIG. 9 represents time (elapsed time), and the vertical axis represents the temperature in the vicinity of the opposing arc contact 11. From FIG. 9, it can be seen that the temperature drops rapidly from the high temperature state caused by the arc discharge Ad, by blowing the arc-extinguishing gas onto the arc discharge Ad and letting it flow out into the sealed container 30. As a result, the current is interrupted.

Note that the jet holes simply need to be able to eject an unsteady jet flow of the arc-extinguishing gas from the insulating nozzle toward the arc discharge, and are not limited to the jet holes of the above embodiments (first embodiment and second embodiment).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A gas circuit breaker, comprising:
a container filled with an arc-extinguishing gas;
an opposing part that is housed in the container, the opposing part including an opposing arc contact and an exhaust stack;
a movable part that is housed in the container, the movable part including: a movable arc contact that comes in contact with the opposing arc contact in a connected state, and separates from the opposing arc contact in an open state; and a pressure accumulation part where a pressure of the arc-extinguishing gas is increased; and
a nozzle that is housed in the container, the nozzle including a space where arc discharge occurs between the movable arc contact and the opposing arc contact, wherein
the nozzle comprises:
a middle part where the opposing arc contact is inserted, and
one or more jet holes that eject, toward the space, part of the arc-extinguishing gas flowing in from a first flow passage between the pressure accumulation part and the middle part, and
the arc-extinguishing gas whose pressure is increased in the pressure accumulation part flows into the space via the first flow passage and the jet holes to extinguish the arc discharge.

2. The gas circuit breaker according to claim 1, wherein the nozzle comprises one or more second flow passages where part of the arc-extinguishing gas flowing in the first flow passage flows in, the one or more second flow passages allowing inflow arc-extinguishing gas to flow out to the one or more jet holes.

3. The gas circuit breaker according to claim 1, wherein the nozzle comprises a housing part where part of the arc-extinguishing gas flowing in the first flow passage flows in, the housing part housing inflow arc-extinguishing gas and ejecting the housed arc-extinguishing gas from the one or more jet holes.

4. The gas circuit breaker according to claim 1, wherein
the nozzle includes one or more inflow holes where part of the arc-extinguishing gas flowing in the first flow passage flows in, and
each of the one or more jet holes ejects, toward the space, the arc-extinguishing gas flowed in from any of the one or more inflow holes.

5. The gas circuit breaker according to claim 1, wherein
the nozzle includes a diameter-enlarged part with a diameter expanding from the middle part toward an end part on a side of the opposing arc contact, and
each of the one or more jet holes is provided in the middle part or the diameter-enlarged part.

6. The gas circuit breaker according to claim 1, wherein the arc-extinguishing gas is a gas that
has a lower global warming potential than a sulfur hexafluoride gas has,
has a lower molecular weight than the sulfur hexafluoride gas has, and
is in a gas phase at least at 1 atmospheric pressure or higher and 20 degrees Celsius or lower.
